(19) United States
(12) Patent Application Publication
(10) Pub. No.: US 2024/0203129 A1
(43) Pub. Date: Jun. 20, 2024

(54) GROUND PLANE FITTING METHOD, VEHICLE-MOUNTED DEVICE AND STORAGE MEDIUM

(71) Applicant: HON HAI PRECISION INDUSTRY CO., LTD., New Taipei (TW)

(72) Inventors: JUNG-HAO YANG, New Taipei (TW); CHIN-PIN KUO, New Taipei (TW); CHIH-TE LU, New Taipei (TW)

(21) Appl. No.: 18/135,037

(22) Filed: Apr. 14, 2023

(30) Foreign Application Priority Data
Dec. 19, 2022 (CN) 202211634941.1

(51) Int. Cl. G06V 20/56; B60W 40/10

(52) U.S. Cl. CPC G06V 20/56; B60W 40/10; B60W 2420/42

(57) ABSTRACT

A ground plane fitting method applied to a vehicle-mounted device is provided. In the method, the vehicle-mounted device acquires a plurality of point clouds of a scene front of a vehicle along a traveling direction and a target image and determines a set of ground point clouds corresponding to the target image according to the plurality of point clouds and the target image. The vehicle-mounted device further obtains multiple ground normal vectors by correcting multiple normal vectors of multiple cameras using to acquire the target images; and fits the ground plane in the traveling direction of the vehicle according to the set of ground point clouds and the obtained ground normal vectors to obtain a fitted ground plane. The method can improve an accuracy of the obtained ground normal vector, thereby effectively improving the accuracy of fitting the ground plane and assisting the safe of the self-driving vehicle.

### FIELD

The present disclosure relates to a safe driving technology, in particular to a ground plane fitting method, a vehicle-mounted device, and a storage medium.

### BACKGROUND

In an automatic driving technology, fitting a plane of a ground in front of a self-driving vehicle is indispensable. The driving of the self-driving vehicle can be controlled according to the fitted ground plane. For example, when there is a downhill having a large lope ahead of the ground, the self-driving vehicle is controlled to slow down. However, issues remain in low fitting accuracy in the existing ground plane fitting methods.

### BRIEF DESCRIPTION OF THE DRAWINGS

FIG. 1 is a flowchart of a ground plane fitting method provided by an embodiment of the present disclosure.

FIG. 2 is a flowchart of a method for determining a set of plane point clouds of a target image provided by an embodiment of the present disclosure.

FIG. 3 is a flowchart of obtaining multiple ground normal vectors provided by an embodiment of the present disclosure.

FIG. 4 is a flowchart of determining a camera coordinate system provided by an embodiment of the present disclosure.

FIG. 5 is a schematic structural diagram of a vehicle-mounted device provided by an embodiment of the present disclosure.

### DETAILED DESCRIPTION

Plurality of embodiments are described in the present disclosure, but the description is exemplary rather than limiting, and there may be more embodiments and implementation solutions within the scope of the embodiments described in the present disclosure. Although many possible combinations of features are shown in the drawings and discussed in the detailed description, many other combinations of the disclosed features are also possible. Unless specifically limited, any feature or element of any embodiment may be used in combination with or in place of any other feature or element of any other embodiment.

When describing representative embodiments, the specification may present methods and/or processes as a specific sequence of steps. However, to the extent that the method or process does not depend on the specific order of steps described in the present disclosure, the method or process should not be limited to the specific order of steps described. As understood by those of ordinary skills in the art, other orders of steps are also possible. Therefore, the specific order of steps set forth in the specification should not be interpreted as limitation to the claims. In addition, the claims for the method and/or process should not be limited to the steps performed in the written order, and those of skill in the art may readily understand that these orders may vary and still remain within the essence and scope of the embodiments of the present disclosure.

Unless otherwise defined, technical terms or scientific terms used in the embodiments shall have their common meanings as construed by those of ordinary skills in the art to which the present disclosure pertains. The terms “first”, “second” and the like used in the embodiments of the present disclosure do not represent any order, quantity, or importance, but are merely used to distinguish between different components. The terms “include”, “contain” or the like mean that elements or articles appearing before such terms may cover elements or articles listed after the words and their equivalents without excluding other elements or articles. The terms “connect”, “link” or the like are not limited to physical or mechanical connection, but may include electrical connections, whether direct or indirect.

In one embodiment, in an automatic driving technology, fitting a plane of a ground in front of a self-driving vehicle is an indispensable part. The driving of the self-driving vehicle can be controlled according to the fitted ground plane, for example, when indicating that there is a downhill having a large lope ahead of the ground, the self-driving vehicle is controlled to slow down. There are problems such as low fitting accuracy in the existing ground plane fitting methods.

In order to solve the above problems, a ground plane fitting method is provided in an embodiment of the present disclosure. The method includes: determining a set of ground point clouds corresponding to a target image according to several point clouds of the vehicle's traveling direction and the target image; obtaining multiple ground normal vectors by correcting multiple normal vectors of multiple cameras using to acquire the target images; and fitting the ground plane in the traveling direction of the vehicle according to the set of ground point clouds and the obtained ground normal vectors to obtain a fitted ground plane. The method can improve an accuracy of the obtained ground normal vector, thereby effectively improving the accuracy of fitting the ground plane and assisting the safe of the self-driving vehicle.

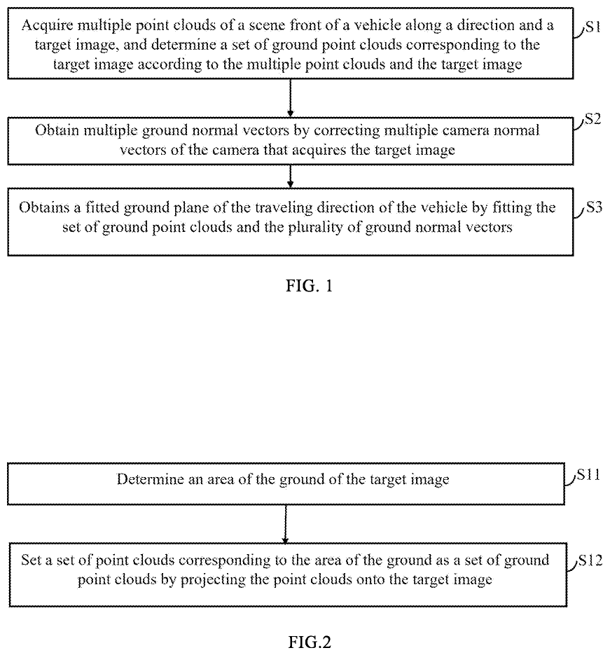

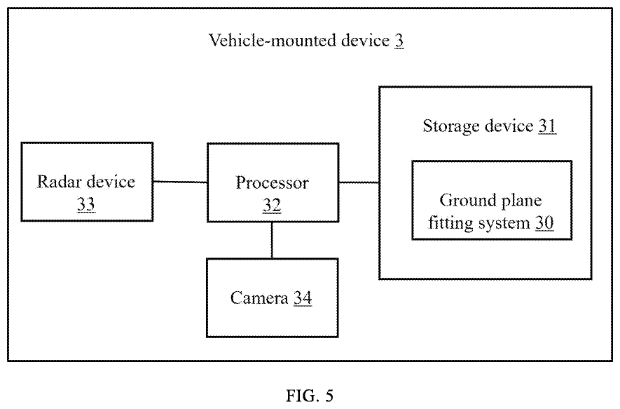

FIG. 1 is a flowchart of a ground plane fitting method provided by an embodiment of the present disclosure. In one embodiment, the method for fitting a ground plane is applied in a vehicle-mounted (e.g., the vehicle-mounted device 3 shown in FIG. 5). The vehicle-mounted device can be integrated with a collision warning function, or the collision warning function can be run on the vehicle-mounted device in a form of a software development kit (SDK).

FIG. 1 illustrates a flowchart of an embodiment of a method for fitting a ground plane. The method is provided by way of example, as there are a variety of ways to carry out the method. Each block shown in FIG. 1 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block S1.

At block S1, the vehicle-mounted device acquires multiple point clouds of a scene front of a vehicle along a direction and a target image, and determines a set of ground point clouds corresponding to the target image according to the multiple point clouds and the target image.

In one embodiment, the vehicle-mounted device may include multiple sensors. For example, a point cloud acquisition device and an image acquisition device. Specifically, the point cloud acquisition device may include a radar device (such as a millimeter-wave radar), and the image acquisition device may include a camera (such as a monocular camera). In this embodiment of the present disclosure, the vehicle-mounted device can be a device configured in a vehicle, installed in the vehicle and has a corresponding software system to execute various instructions. The vehicle-mounted device can also be an independent electronic device, for example, an external electronic device (such as mobile phones, computers, tablets and so on) that can communicate with the vehicle. The vehicle-mounted device obtains vehicle data and controls the vehicle.

The radar device can be installed in the vehicle, such as installed in a front windshield of the vehicle, to obtain multiple point clouds (for example, three-dimensional point clouds) of a scene front of a vehicle along the vehicle's traveling direction. The camera can be installed in the front of the vehicle, such as installed in the front windshield of the vehicle, to obtain images of the scene front of the vehicle along the vehicle's traveling direction (e.g., two-dimensional (2D) images). The camera can be a driving recorder installed in the vehicle. Or the camera can be installed on the vehicle or can be an independent device connected to the vehicle-mounted device through a network or the like. The number of the camera can be one or more. Practical applications are not limited to the above examples.

In one embodiment, according to a frame rate of the camera, each image obtained by the camera includes a corresponding timestamp. For example, if the frame rate of the camera is 30 frames per second, then a time interval between two timestamps corresponding to two adjacent images is 1/30 second.

In one embodiment, the target image may be any one of 2D images of the traveling direction of the vehicle obtained by the camera, and the timestamp corresponding to the target image may be set as a target timestamp. The ground plane fitting method provided in the embodiment of the present disclosure is used to fit the ground plane in the traveling direction of the vehicle corresponding to the target timestamp. Then, the vehicle-mounted device controls the driving of the self-driving vehicle according to the fitted ground plane.

In one embodiment, the block S1 can describe in detail with reference to the flowchart shown in FIG. 2. FIG. 2 is a flowchart of a method for determining a set of ground point clouds corresponding to the target image provided by the embodiment of the present disclosure, which specifically includes the following blocks:

In block S11, the vehicle-mounted device determines an area of the ground of the target image.

In one embodiment, there are many image recognition methods for determining the area of the ground of the target image, including but not limited to: recognizing the area of the ground by using a semantic segmentation algorithm to the target image.

In one embodiment, the vehicle-mounted device performs a semantic segmentation algorithm on the target image, which can recognize different semantic categories (for example, ground, vehicle) according to the pixels of the target image, and can classify pixels of the target image point by point, so as to group or segment the pixels of the target image, and the vehicle-mounted device determines areas where different types of objects are located on (for example, an area of ground).

In an embodiment, the vehicle-mounted device uses a semantic segmentation model to determine the area of the ground of the target image. The vehicle-mounted device obtains many training samples of the images; pretrains the semantic segmentation model according to the training samples; determines the area of the ground after inputting the target image into the semantic segmentation model. Wherein, the semantic segmentation model may include a dilated convolution semantic segmentation model based on a full convolution, for example, a RefineNet model.

Specifically, the RefineNet model network includes multiple independent RefineNet modules. Each RefineNet module includes: a residual convolutional unit (Residual Convolutional Unit, RCU) block, a multi-resolution fusion (Multi-Resolution Fusion, MRF) layer and a chain residual pooling (Chain Residual Pooling, CRP) layer. The RCU block includes a convolution set according to an adaptive block, which is used to segment the target image based on weights of the ResNet; the MRF layer fuses different activations and uses convolution and UN sampling layers to improve the resolution of the target image; the CRP layer pool uses multiple Kernels of various sizes to obtain global receptive fields from larger image regions.

In block S12, the vehicle-mounted device sets a set of point clouds corresponding to the area of the ground as a set of ground point clouds by projecting the point clouds onto the target image.

In at least one embodiment, the vehicle-mounted device projects the point clouds onto the target image by jointly calibrating the radar device that obtains the point clouds and the camera that obtains the target image; and fuses the point clouds with the target image.

In a multi-sensor detection system which includes the radar device and the camera device, the two sensors are jointly calibrated before fusing the radar information with the image information, so as to obtain a relationship between each point of the point clouds and each pixel of the image, then the 3D point clouds is projected onto the 2D image, completing the fusion of radar information and image information.

In one embodiment, the vehicle-mounted device jointly calibrates and fuses the radar information and the image information by obtaining external parameters (e.g., a rotation matrix, a translation vector, etc.) of the radar device and the camera device, and obtaining a transformation matrix between a world coordinate system based on the location of the radar device and a coordinate system based on the location of the camera device according to the external parameters. For example, the vehicle-mounted device calculates the transformation matrix ed by using a Perspective-n-Point algorithm, and projects the points of the 3D point cloud coordinate system to the 3D coordinate system where the camera device is located based on the transformation matrix. the vehicle-mounted device obtains multiple internal parameters (e.g., focal length, principal point, tilt coefficient, distortion coefficient, etc.) of the camera device by calibrating the camera device, removes any distortion of a convex lens of the camera device based on the internal parameters; and projects the points in the 3D coordinate system where the camera device is located onto the 2D image. In detail, a variety of calibration tools can be used to implement the above process, for example, the sensor calibration tool of Apollo, Calibration Tookit module of AUTOWARE, and the like.

In one embodiment, after the vehicle-mounted device projects the point clouds onto the target image, the vehicle-mounted device sets the set of point clouds corresponding to the ground area of the target image as the set of ground point clouds of the point clouds.

In block S2, the vehicle-mounted device obtains multiple ground normal vectors by correcting multiple camera normal vectors of the camera that acquires the target image.

In one embodiment, since the ground on which the self-driving vehicle is driven has a slope, when the vehicle is tilted due to the slope of the ground, a deflection angle of the reference world coordinate system of the camera installed in the vehicle will be changed. If the camera pose of the camera is always determined according to the original world coordinate system, and the camera normal vector corresponding to the camera pose is used as the ground normal vector, the fitted ground plane will have a large error. Therefore, the camera normal vector needs to be corrected.

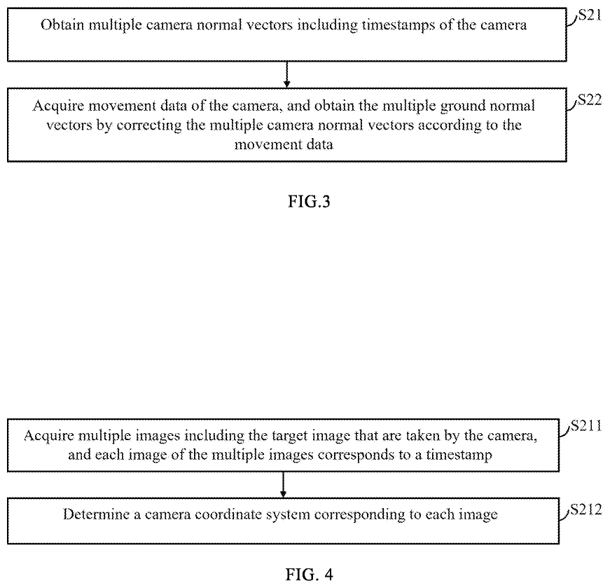

In one embodiment, the detailed flow of block S2 is described with reference to FIG. 3. FIG. 3 is a flowchart for obtaining multiple ground normal vectors provided by the embodiment of the present disclosure, which specifically includes the following blocks:

In block S21, the vehicle-mounted device obtains multiple camera normal vectors including timestamps of the camera.

In an embodiment, a deflection angle of the camera normal vector of the camera may be used as a deflection angle of the reference world coordinate system of the camera. When determining the camera normal vector, the camera coordinate system of the camera may be determined first.

In at least one embodiment of the present disclosure, a flowchart of the vehicle-mounted device determines the camera coordinate system can refer to the process shown in FIG. 4, which specifically includes the following blocks:

In block S211, the vehicle-mounted device acquires multiple images including the target image that are taken by the camera, and each image of the multiple images corresponds to a timestamp.

In an embodiment, the multiple images may be multiple consecutive images with the target image as the last one. For example, after the target image is determined, the vehicle-mounted device obtains three consecutive images by inversion from the target image images. The target image is the last image of the three consecutive images. For the description of the timestamp, reference may be made to the corresponding records in block S1.

Due to a relatively high frame rate of the camera, the actual time span of the multiple images is very small, the multiple consecutive images can be regarded as a group of images captured by the vehicle on the same ground. For example, when there are three consecutive images and the frame rate of the camera is 30 frames per second, the actual corresponding time span is only (3−1)× 1/30= 1/15 second. A distance traveled by the vehicle within 1/15 second is very short, so the multiple consecutive images can be regarded as a group of images captured by the vehicle on the same ground.

In block S212, the vehicle-mounted device determines a camera coordinate system corresponding to each image.

In one embodiment, the camera coordinate system corresponding to each image may change slightly due to the change of the ground slope, therefore, there is a need to determine the camera coordinate system corresponding to each image. Specifically, the vehicle-mounted device determines a rotation matrix and a translation matrix between the camera and the referenced world coordinate system by referring to the internal and external parameters of the camera in block S1, and determines the camera coordinate system according to the rotation matrix and the translation matrix. The method of determining the camera coordinate system is a commonly used technical means in the field and will not be described in detail.

In one embodiment, after the camera coordinate system is determined, the vehicle-mounted device obtains multiple camera normal vectors including timestamps of the camera by setting a coordinate axis pointing to the sky of the camera coordinate system of the camera as the camera normal vector. For example, if the camera coordinate system is an OXYZ coordinate system determined according to the right-hand rule, the camera normal vector represents the Z axis pointing to the sky.

In one embodiment, the vehicle-mounted device obtains multiple camera normal vectors corresponding to the multiple images in the above embodiment, can improve an accuracy of a corrected ground normal vector in subsequent blocks.

In block S22, the vehicle-mounted device acquires movement data of the camera and obtains the multiple ground normal vectors by correcting the multiple camera normal vectors according to the movement data.

In one embodiment, in order to correct the normal vector of the camera, the vehicle-mounted device further includes an inertial motion unit (Inertial Motion Unit, IMU) sensor. The IMU sensor can be installed inside or outside of the camera, the IMU sensor includes an accelerometer and a gyroscope sensor, which can be used to detect the movement data (such as acceleration and angular velocity and so on) of the camera at every moment. Thus, the movement data including the timestamp is acquired.

Furthermore, a time accuracy of the IMU sensor is greater than a time accuracy corresponding to the frame rate of the camera. For example, the camera acquires a picture every 1/30 second, while the IMU sensor acquires the movement data every 1/60 second. Therefore, the timestamp corresponding to each image can correspond to the movement data of the same timestamp, so that each camera normal vector corresponding to each image can correspond to the movement data of the same timestamp, wherein the movement data including a gravitational acceleration.

In one embodiment, the vehicle-mounted device corrects the rotation matrix of the camera pose of the camera according to a direction of the gravitational acceleration; and corrects the camera normal vector to the ground normal vector.

In one embodiment, the direction of the gravitational acceleration is the same as a direction pointing to a center of the earth, which will not change in a short time, so the directions of the gravitational acceleration corresponding to the normal vectors of the multiple cameras are unified, so the direction of the gravitational acceleration can be used to correct the rotation matrix of the camera pose. The camera pose represents the position and attitude of the camera relative to the world coordinate system, and the camera pose includes a rotation matrix between the camera coordinate system and the world coordinate system. The rotation matrix includes three matrices. One of the three matrices is a normal vector rotation matrix corresponding to the deflection angle between the camera normal vector and the vertical axis of the world coordinate system pointing to the sky.

Specifically, the vehicle-mounted device determines a deflection angle between the opposite direction of the direction of the gravitational acceleration and the direction of the vertical axis of the world coordinate system pointing to the sky; determines the deflection matrix between the reverse direction and the direction of the vertical axis of the world coordinate system pointing to the sky according to the deflection angle, and obtains the corrected normal vector rotation matrix by multiplying the deflection matrix with the normal vector rotation matrix of the camera pose; and obtains the corrected rotation matrix of the camera pose formed by the corrected normal vector rotation matrix. A method of determining the rotation matrix of the world coordinate system according to the deflection angle or the rotation angle may adopt a common method in the technical field and will not be described again.

In one embodiment, after obtaining the corrected rotation matrix of the camera pose, the corrected camera coordinate system of the camera can be obtained, thereby the vehicle-mounted device obtains the corrected camera normal vector as the ground normal vector.

In block S3, the vehicle-mounted device obtains a fitted ground plane of the traveling direction of the vehicle by fitting the set of ground point clouds and the plurality of ground normal vectors.

In one embodiment, the vehicle-mounted device obtains a fitted ground plane of the traveling direction of the vehicle by fitting the set of ground point clouds and the plurality of ground normal vectors includes: sets the set of ground point clouds and the plurality of ground normal vectors as constraint conditions for fitting a ground plane equation, and obtains the ground plane corresponding to the ground by using least squares method fitting the ground plane of the traveling direction of the vehicle based on the constraint conditions.

In one embodiment, usually when using the least squares method fitting the ground plane, a ground normal vector and a set of ground point clouds are used as the constraint condition or only a set of ground point clouds containing depth information is used as the constraint condition. However, the accuracy of the ground plane is difficult to guarantee. Therefore, in the embodiment of the present disclosure, a more accurate ground plane can be obtained by using the multiple ground normal vectors obtained in the above embodiments.

In one embodiment, the method of fitting the plane equation by the least square method is a common technique in the art, and its basic principle includes using a square of the minimum error between multiple data (for example, multiple ground normal vectors or multiple sets of ground point clouds) and finding best function matches for the, no longer described.

In one embodiment, after obtaining the ground plane, the self-driving vehicle can be controlled to drive according to the ground plane. For example, when there is a steep uphill slope ahead of the ground, the speed of the self-driving vehicle can be controlled to increase.

In addition, in the above embodiment, in the method, the vehicle-mounted device divides the area of the ground into multiple sub-areas, and obtains multiple ground planes by fitting multiple sets of ground point clouds corresponding to the multiple sub-areas. The method can further improve an accuracy of the ground ahead of the vehicle. The accuracy of the ground indicates a more precise direction of travel for the self-driving vehicle and improves the ride experience for the users in the vehicle. For example, if the ground plane corresponding to a certain sub-area indicates that there is a subsidence, the vehicle can be controlled to avoid the collapsed ground to prevent the passengers in the vehicle from feeling bumpy.

In one embodiment, in the ground plane fitting method provided by the present disclosure, the vehicle-mounted device acquires a plurality of point clouds of a scene front of a vehicle along a traveling direction and a target image, and determines a set of ground point clouds corresponding to the target image according to the plurality of point clouds and the target image. The vehicle-mounted device further obtains multiple ground normal vectors by correcting multiple normal vectors of multiple cameras using to acquire the target images; and fits the ground plane in the traveling direction of the vehicle according to the set of ground point clouds and the obtained ground normal vectors to obtain a fitted ground plane. The method can improve an accuracy of the obtained ground normal vector, thereby effectively improving the accuracy of fitting the ground plane and assisting the safe of the self-driving vehicle.

The above-mentioned FIG. 1 has introduced the ground plane fitting method of the present disclosure in detail, and below in conjunction with FIG. 5, the functional modules of the software system for realizing the described ground plane fitting method and the hardware device architecture for realizing the described ground plane fitting method are introduced.

It should be understood that the embodiments are only for illustration, and are not limited by the structure in terms of the scope of the present disclosure.

FIG. 5 is a schematic structural diagram of a vehicle-mounted device provided by an embodiment of the present disclosure. In at least one embodiment, the vehicle-mounted device 3 includes a storage device 31, at least one processor 32, at least one radar device 33, and at least one camera 34 Those skilled in the art should understand that the structure of the vehicle-mounted device shown in FIG. 5 does not constitute a limitation of the embodiment of the present disclosure, more or less other hardware or software, or a different arrangement of components.

In some embodiments, the vehicle-mounted device 3 includes a terminal capable of automatically performing numerical calculation and/or information processing according to preset or stored instructions, and its hardware includes but not limited to microprocessors, application-specific integrated circuits, programmable gate arrays, digital processors and embedded devices, etc.

It should be noted that the vehicle-mounted device 3 is only an example, and other existing or future electronic products that can be adapted to this application should also be included in the scope of protection of this disclosure and are included here by reference.

In some embodiments, the storage device 31 is used to store program codes and various data. For example, the storage device 31 can be used to store the ground plane fitting system 30 installed in the vehicle-mounted device 3 and realize high-speed and automatic program or data access during the operation of the vehicle-mounted device 3. The storage device 31 includes a read-only memory (Read-Only Memory, ROM), a programmable read-only memory (Programmable Read-Only Memory, PROM), an erasable programmable read-only memory (Erasable Programmable Read-Only Memory, EPROM), One-time Programmable Read-Only Memory (OTPROM), Electronically Erasable Programmable Read-Only Memory (EEPROM), Compact Disc Read-Only Memory (EEPROM), Only Memory, CD-ROM) or other optical disk storage, magnetic disk storage, tape storage, or any other computer-readable storage medium that can be used to carry or store data.

In some embodiments, the at least one processor 32 may be include an integrated circuit, for example, may be include a single packaged integrated circuit, or may be include multiple integrated circuits with the same function or different functions packaged, including one or more central processing units (Central Processing unit, CPU), microprocessors, digital processing chips, graphics processors, and various control chips. The at least one processor 32 is the control core (Control Unit) of the vehicle-mounted device 3, and uses various interfaces and lines to connect various components of the entire vehicle-mounted device 3, by running or executing programs stored in the storage device 31 or module, and call the data stored in the storage device 31 to execute various functions of the vehicle-mounted device 3 and process data, for example, to execute the function of ground plane fitting method shown in FIG. 1.

In this embodiment, the ground plane fitting system 30 can be divided into multiple functional modules according to the functions it performs. The module referred to in this application refers to a series of computer program segments that can be executed by at least one processor and can complete fixed functions and are stored in a memory.

Although not shown, the vehicle-mounted device 3 may also include a power supply (such as a battery) that supplies power to various components. The power supply may be logically connected with processor 32 through a power management device, thereby achieving functions such as managing charge, discharge, and power consumption management through a power management device. The power supply may also include one or more DC or AC power supplies, recharging devices, power failure test circuits, power converters or inverters, power status indicators and other arbitrary components. The vehicle-mounted device 3 can also include a variety of sensors, Bluetooth module, Wi-Fi module, etc., which is not described.

It is understood that the division of modules described above is a logical functional division, and there can be another division in actual implementation. In addition, each functional module in each embodiment of the present application may be integrated in the same processing unit, or each module may physically exist separately, or two or more modules may be integrated in the same unit. The above integrated modules can be implemented either in the form of hardware or in the form of hardware plus software functional modules. The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A ground plane fitting method using a vehicle-mounted device, the method comprising:
acquiring a plurality of point clouds of a scene front of a vehicle along a traveling direction and a target image;
determining a set of ground point clouds corresponding to the target image according to the plurality of point clouds and the target image;
obtaining a plurality of ground normal vectors by correcting a plurality of camera normal vectors of a camera that acquires the target image; and
obtaining a fitted ground plane of a ground of the scene along the traveling direction of the vehicle by fitting the set of ground point clouds and the plurality of ground normal vectors.

2. The ground plane fitting method according to claim 1, wherein determining the set of ground point clouds corresponding to the target image according to the plurality of point clouds and the target image comprises:
determining an area of the ground of the target image; and
setting a set of point clouds corresponding to the area of the ground as a set of ground point clouds by projecting the point clouds onto the target image.

3. The ground plane fitting method according to claim 2, wherein the area of the ground is determined by using a semantic segmentation algorithm to the target image.

4. The ground plane fitting method according to claim 1, wherein obtaining the plurality of ground normal vectors by correcting the plurality of camera normal vectors of the camera that acquires the target image comprises:
obtaining the plurality of camera normal vectors, which comprise timestamps of the camera; and
acquiring movement data of the camera and obtaining the plurality of ground normal vectors by correcting the plurality of camera normal vectors according to the movement data.

5. The ground plane fitting method according to claim 4, further comprising:
setting a coordinate axis pointing to a sky of a camera coordinate system of the camera as the camera normal vector.

6. The ground plane fitting method according to claim 5, further comprising:
acquiring a plurality of images comprising the target image that are taken by the camera, each image of the plurality of images corresponding to a timestamp; and
determining a camera coordinate system corresponding to each image.

7. The ground plane fitting method according to claim 4, wherein obtaining the plurality of ground normal vectors by correcting the plurality of camera normal vectors according to the movement data comprises:
obtaining a gravitational acceleration from the movement data; and
correcting the camera normal vector to the ground normal vector by correcting a rotation matrix of a camera pose of the camera according to a direction of the gravitational acceleration.

8. A vehicle-mounted device comprising:
a storage device;
at least one processor; and
the storage device storing one or more programs, which when executed by the at least one processor, cause the at least one processor to:
acquire a plurality of point clouds of a scene front of a vehicle along a traveling direction and a target image;
determine a set of ground point clouds corresponding to the target image according to the plurality of point clouds and the target image;
obtain a plurality of ground normal vectors by correcting a plurality of camera normal vectors of a camera that acquires the target image; and
obtain a fitted ground plane of a ground of the scene along the traveling direction of the vehicle by fitting the set of ground point clouds and the plurality of ground normal vectors.

9. The vehicle-mounted device according to claim 8, wherein the at least one processor determines the set of ground point clouds corresponding to the target image according to the plurality of point clouds and the target image by:
determining an area of the ground of the target image; and
setting a set of point clouds corresponding to the area of the ground as a set of ground point clouds by projecting the point clouds onto the target image.

10. The vehicle-mounted device according to claim 9, wherein the area of the ground is determined by using a semantic segmentation algorithm to the target image.

11. The vehicle-mounted device according to claim 8, wherein the at least one processor obtains the plurality of ground normal vectors by correcting the plurality of camera normal vectors of the camera that acquires the target image by:
obtaining the plurality of camera normal vectors, which comprise timestamps of the camera; and
acquiring movement data of the camera and obtaining the plurality of ground normal vectors by correcting the plurality of camera normal vectors according to the movement data.

12. The vehicle-mounted device according to claim 11, wherein the at least one processor is further caused to:
set a coordinate axis pointing to a sky of a camera coordinate system of the camera as the camera normal vector.

13. The vehicle-mounted device according to claim 12, wherein the at least one processor is further caused to:
acquire a plurality of images comprising the target image that are taken by the camera, each image of the plurality of images corresponding to a timestamp; and
determine a camera coordinate system corresponding to each image.

14. The vehicle-mounted device according to claim 11, wherein the at least one processor obtains the plurality of ground normal vectors by correcting the plurality of camera normal vectors according to the movement data by:
obtaining a gravitational acceleration from the movement data; and
correcting the camera normal vector to the ground normal vector by correcting a rotation matrix of a camera pose of the camera according to a direction of the gravitational acceleration.

15. A non-transitory storage medium having instructions stored thereon, when the instructions are executed by a processor of a vehicle-mounted device, the processor is caused to perform a ground plane fitting method, wherein the method comprises:
acquiring a plurality of point clouds of a scene front of a vehicle along a traveling direction and a target image;
determining a set of ground point clouds corresponding to the target image according to the plurality of point clouds and the target image;
obtaining a plurality of ground normal vectors by correcting a plurality of camera normal vectors of a camera that acquires the target image; and
obtaining a fitted ground plane of a ground of the scene along the traveling direction of the vehicle by fitting the set of ground point clouds and the plurality of ground normal vectors.

16. The non-transitory storage medium according to claim 15, wherein determining the set of ground point clouds corresponding to the target image according to the plurality of point clouds and the target image comprises:
determining an area of the ground of the target image; and
setting a set of point clouds corresponding to the area of the ground as a set of ground point clouds by projecting the point clouds onto the target image.

17. The non-transitory storage medium according to claim 16, wherein the area of the ground is determined by using a semantic segmentation algorithm to the target image.

18. The non-transitory storage medium according to claim 15, wherein obtaining the plurality of ground normal vectors by correcting the plurality of camera normal vectors of the camera that acquires the target image comprises:
obtaining the plurality of camera normal vectors, which comprise timestamps of the camera; and
acquiring movement data of the camera and obtaining the plurality of ground normal vectors by correcting the plurality of camera normal vectors according to the movement data.

19. The non-transitory storage medium according to claim 18, wherein the method further comprises:
setting a coordinate axis pointing to a sky of a camera coordinate system of the camera as the camera normal vector.

20. The non-transitory storage medium according to claim 19, wherein the method further comprises:
acquiring a plurality of images comprising the target image that are taken by the camera, each image of the plurality of images corresponding to a timestamp; and
determining a camera coordinate system corresponding to each image.
